(19) United States
(12) Patent Application Publication
(10) Pub. No.: US 2010/0039718 A1
(43) Pub. Date: Feb. 18, 2010

(54) LENS MODULE

(76) Inventors: Yukio Nishimiya, Miyagi (JP); Syuji Aisawa, Miyagi (JP); Daisuke Yamazaki, Miyagi (JP); Miho Chiba, Miyagi (JP); Tomohiro Yonezawa, Miyagi (JP); Kazunori Honda, Miyagi (JP); Wei Gao, Miyagi (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/299,085

(22) PCT Filed: Sep. 25, 2007
(86) PCT No.: PCT/JP2007/068582

§ 371 Date: Oct. 30, 2008

(30) Foreign Application Priority Data
Sep. 26, 2006 (JP) 2006-260222

(51) Int. Cl. G02B 7/04

(52) U.S. Cl. 359/824

(57) ABSTRACT

In order to provide a lens module having a simply structured lens drive mechanism that is capable of stabilizing the moving speed of an optical lens system, the lens module has a structure wherein a lens holder (to which no illustrated optical lens system is mounted) (6) that mounts a moving body (5) attractable to a magnet (4) is mounted on a housing (7) using guide pins (8), and wherein one side of a piezoelectric ceramic element (3) is adhered to the magnet (4) in the displacement generating direction (longitudinal direction) of the piezoelectric ceramic element 3, and the other side thereof is adhered to the housing (7), with the moving body (5) and the magnet (4) being attracted by a magnetic force. The lens holder (6) supporting the moving body (5) is movably supported by the guide pins (8). The magnetization direction of the magnet (4) is substantially orthogonal to an optical axis direction of the optical lens system and is a radial direction of the optical lens system. The lens drive mechanism moves the lens holder (6) along the optical axis direction by vibrating the magnet (4) using vibrations generated by the piezoelectric ceramic element (3), and by driving the moving body (5) with the vibrations of the magnet (4) as a driving force.

### TECHNICAL FIELD

The present invention relates to a lens module suitably applicable mainly to a digital video camera, a digital camera, a camera for use in a mobile phone, or the like. More specifically, the present invention pertains to a lens module suitably applicable to an optical device having an auto-focus mechanism and/or a zoom mechanism and also having an optical lens system moving toward a predetermined direction.

### BACKGROUND ART

In order to provide the camera with the auto-focus function or the zoom function, a mechanism for moving an optical lens system along an optical axis is needed. As methods for achieving this purpose, methods using an electromagnetic motor have been commonly known.

However, in recent optical devices typified by the digital camera or the mobile phone with a camera, with a rapid progress toward miniaturization thereof, techniques have been proposed that use a moving method for the optical lens system by means of an electromechanical transducer, such as a piezoelectric element, in place of the electromagnetic motor, and these techniques are becoming main stream.

Examples of such known techniques include: a drive device comprising a driving member that is frictionally engaged with a driven body or a member connected to the driven body and that is movably supported by a stationary member, a piezoelectric element wherein one end thereof is fixed to the driving member and the other end thereof is immovably connected to the stationary member or the like, and piezoelectric element drive means for applying a voltage to the piezoelectric element so as to make expansion speed and contraction speed of the piezoelectric element different from each other (confer to Patent Document 1); a drive mechanism comprising a driving member made of a magnetic material, and a movable lens group frame that has an exciting member for exciting the driving member and that is driven by the driving member, wherein the driving member is driven by an electromechanical transducer (confer to Patent Document 2); a drive device comprising a drive mechanism that is connected to an electromechanical transducer and that frictionally engaging a driven member with a driving member that displaces together with the electromechanical transducer, wherein a magnet is used as means for imparting a pressuring force for frictionally engaging the driving member with the driven member (confer to Patent Document 3); and a drive mechanism comprising a vibration shaft fixed to an end of a piezoelectric element, and a collision element frictionally engaged to the vibration shaft, wherein the collision element is driven by driving the vibration shaft with the piezoelectric element, and the vibration shaft is constituted by a magnet.

Patent Document 1: JP-B-2633066 (claims)

Patent Document 2: JP-A-H10-10401 (claims)

Patent Document 3: JP-A-H7-274546 (claims; paragraph [0033])

Patent Document 4: JP-A-H7-13061 (paragraphs [0033] to [0038])

### DISCLOSURE OF INVENTION

### Problems to be Solved by the Invention

The above-described known techniques using methods for moving optical lens system by electromechanical transducer each involve structural problems.

Specifically, in the method disclosed by Patent Document 1, a structure for supporting the driving member so as to be movable to the stationary member is needed, and it is necessary to frictionally engaging the driven body with the driving member using an elastic member such as a leaf spring. This not only complicates the structure of the lens module, but also makes the control of friction force difficult, thereby causing a problem in that the moving speed of the driven body is varied.

In the method disclosed by Patent Document 2, the magnetization direction of the exciting member is uncertain. For example, when the magnetization direction of the exciting member conforms with the moving direction of an optical lens system, magnetic flux distribution becomes up-down asymmetric in a magnetic circuit formed by the exciting member and the driving member which is a magnetic material, depending on the position of the optical lens system. This raises a problem of making a significant difference in moving speed between during lens extension and during lens withdrawal.

In the method disclosed by Patent Document 3, because there are many places where a moving shaft for moving the optical lens system substantially frictionally engaged with other members, it is complicated to control frictional forces of frictionally engaged portions, thereby incurring a problem of making it difficult to stably drive the optical lens system.

Furthermore, in the method disclosed by Patent Document 4, because a shape of the contact portion of the collision element that is frictionally engaged with the drive shaft constituted by a magnet is of an arcuate groove shape, it is difficult to manage the surface state with associated with a friction coefficient during frictional engagement. When attempting to apply such a structure to lens driving, there occurs a problem that accurate positioning of the optical lens system becomes difficult.

In order to simultaneously provide the auto-focus function and the zoom function to the camera, it is necessary to individually drive at least two lenses, and hence, two drive device for driving the lenses are needed. As a result, when attempting to concurrently realize the auto-focus function and the zoom function, a problem of the complication and upsizing of the camera occurs.

The present invention has been made to solve these problems, and it is a technological object thereof to provide a lens module having a simply structured lens drive mechanism capable of stabilizing the moving speed of the optical lens system. It is another technological object of the present invention to provide a simply structured and compact lens module concurrently having the auto-focus function and the zoom function.

### Means Undertaken to Solve the Above Problems

According to a first aspect of the present invention, there is provided a lens module which comprises a driving body including an electromechanical transducer serving as a driving element and having one end adhered to a magnet and the other end fixed to a stationary member; a moving member constituted by a material attractable to the magnet; a lens holder formed integrally with the moving member; and an optical lens system supported by the lens holder, or formed integrally with the lens holder. The magnetization direction of the magnet is substantially orthogonal to an optical axis direction of the optical lens system and is a radial direction or an outer peripheral direction of the optical lens system. The lens module further comprises a lens drive mechanism having a function of moving the lens holder along the optical axis direction by vibrating the magnet using vibrations generated by the electromechanical transducer, and by driving the moving member with the vibrations of the magnet as a driving force.

According to a second aspect of the present invention, there is provided a lens module which comprises a driving body including a first electromechanical transducer serving as a first driving element and having one end adhered to a magnet and the other end fixed to a stationary member and a second electromechanical transducer serving as a second driving element and having one end adhered to the magnet in a direction orthogonal to the displacement generating direction of the first electromechanical transducer and the other end fixed to the stationary member; a moving member having a cylindrical shape and being constituted by a material attractable to the magnet; a first lens holder formed integrally with the moving member; a first optical lens system supported by the first lens holder, or formed integrally with the first lens holder; a second lens holder supported so as to be movable in an optical axis direction of the moving member by a rotational movement of the moving member; and a second optical lens system supported by the second lens holder, or formed integrally with the second lens holder; the magnetization direction of the magnet being substantially orthogonal to an optical axis direction of the first and the second optical lens systems and being a radial direction or an outer peripheral direction of the first and the second optical lens systems, the lens module further comprising a lens drive mechanism having a function of moving the first and the second lens holders along the optical axis direction by vibrating the magnet in the optical axis direction using vibrations generated by the first driving element, and by driving the moving member in the optical axis direction with the vibrations of the magnet as a driving force; and a function of moving the second lens holder along the optical axis direction by vibrating the magnet in an outer peripheral direction of the moving member using vibrations generated by the second driving element, and by rotating the moving member with the vibrations of the magnet as a driving force.

According to a third aspect of the present invention, there is provided a lens module which comprises a driving body including a first electromechanical transducer serving as a first driving element and having one end adhered to a magnet and the other end fixed to a stationary member and a second electromechanical transducer serving as a second driving element and having the other end adhered to the magnet in a direction orthogonal to the displacement generating direction of the first electromechanical transducer and the other end fixed to a weight member; a moving member having a cylindrical shape and being constituted by a material attractable to the magnet; a first lens holder formed integrally with the moving member; a first optical lens system supported by the first lens holder, or formed integrally with the first lens holder; a second lens holder supported so as to be movable in an optical axis direction of the moving member by a rotational movement of the moving member; and a second optical lens system supported by the second lens holder, or formed integrally with the second lens holder. The magnetization direction of the magnet is substantially orthogonal to an optical axis direction of the first and the second optical lens systems and is a radial direction or an outer peripheral direction of the first and the second optical lens systems. The lens module further comprises a lens drive mechanism having a function of moving the first and the second lens holders along the optical axis direction by vibrating the magnet in the optical axis direction using vibrations generated by the first driving element, and by driving the moving member in the optical axis direction with the vibrations of the magnet as a driving force; and a function of moving the second lens holder along the optical axis direction by vibrating the magnet in an outer peripheral direction of the moving member using vibrations generated by the second driving element, and by rotating the moving member with the vibrations of the magnet as a driving force.

### ADVANTAGES

In the case of the lens module according to the present invention, there is provided a lens drive mechanism wherein, in a driving body in which one end of an electromechanical transducer serving as a driving element is adhered to a magnet, and the other end thereof is fixed to a stationary member, a moving member constituted by a material attractable to the magnet is attractively engaged with the magnet by a magnetic force generated by the magnet, and wherein the magnetization direction of the magnet is substantially orthogonal to an optical axis direction of the optical lens system, and is a radial direction or an outer peripheral direction of the optical lens system. The lens module according to the present invention further has a function of moving a lens holder in the optical axis direction by vibrating the magnet using vibrations generated by the electromechanical transducer and by driving the moving body with the vibrations of the magnet as a driving force. The described features allow a driving force occurring from vibrations of the electromechanical transducer to be stably conveyed to the moving member, and enable variations in moving speed of the optical lens system to be less than those in the known techniques. Furthermore, in the lens module according to the present invention, since a single driving body can drive two lenses individually, the auto-focus function and the zoom function can be implemented by a compact and simple structure as compared with the cases of the known techniques. Moreover, in the lens module according to the present invention, since an elastic member such as a leaf spring is not needed and frictionally engaged portions decreases, the number of components is reduced and brings about a very simple and stable structure, which facilitates assembling and achieves low cost, thus making the present lens module suitably applicable to a lens module having compact auto-focus and zoom mechanisms. Also, in the lens module according to the present invention, since, between the other end of the electromechanical transducer and the stationary member, a weight member, or the weight member and a vibration damping member are provided, vibrations generated by the electromechanical transducer can be prevented from leaking into a housing or the like, which makes the present lens module suitably applicable to a lens module having compact auto-focus and zoom mechanisms without degrading the imaging property of an image sensor. In addition, in the lens module according to the present invention, since a piezoelectric ceramic element constituted by a laminated piezoelectric ceramic is used for the electromechanical transducer serving as a driving element, even low voltage/low power can provide a sufficient lens driving force in the lens drive mechanism. Besides, since the lens module according to the present invention has no drive shaft (rod) as in the Patent Documents 1 and 2, there is no vibration attenuation by the drive shaft, thereby allowing a stable moving without drive energy loss. That is, according to the lens module of the present invention, the optical lens system can be stably moved along the optical axis direction thereof, as well as it is easy to assemble, less in assembly variations, and easy to downsize, so that the lens module according to the present invention is suitably applicable to the lens module with auto-focus function or zoom function of a camera for use in a mobile phone or digital still camera.

### BRIEF DESCRIPTION OF DRAWINGS

FIG. 1 is a diagram showing an example of schematic construction of a driving body functioning as a critical portion of a lens module according to a first best mode of the present invention, wherein (a) is a side view, and (b) is an end view seen from the right direction indicated by a white arrow in (a).

FIG. 2 is a diagram showing another example of schematic construction of a driving body functioning as a critical portion of a lens module according to the first best mode of the present invention, wherein (a) is a side view, and (b) is an end view seen from the right direction indicated by a white arrow in (a).

FIG. 3 is a diagram showing an example of schematic construction of a driving body functioning as a critical portion of a lens module according to a second best mode of the present invention, wherein (a) is a side view, and (b) is an end view seen from the right direction indicated by a white arrow in (a).

FIG. 4 is a diagram showing an example of schematic construction of a driving body functioning as a critical portion of a lens module according to a third best mode of the present invention, wherein (a) is a side view, and (b) is an end view seen from the right direction indicated by a white arrow in (a).

FIG. 5 is a diagram showing the basic construction of a lens module according to a first example of the present invention, wherein (a) is an external plan view seen from the top surface side of the lens module, and (b) is a sectional side view taken along a line A-A in (a).

FIG. 6 is a diagram showing the basic construction of a lens module according to a second example of the present invention, wherein (a) is an external plan view seen from the top surface side of the lens module, and (b) is a sectional side view taken along a line B-B in (a).

FIG. 7 is a timing chart showing the relationship among the drive voltage change with time, the displacement amount of the piezoelectric ceramic elements, and the moving amount of moving bodies, of piezoelectric ceramic elements provided in the lens modules according to the first example in FIGS. 3(a) and 3(b) and the second example in FIGS. 4(a) and 4(b).

FIG. 8 is a diagram showing the basic construction of a lens module according to a third example of the present invention, wherein (a) is an external plan view seen from the top surface side of the lens module, and (b) is a sectional side view taken along a line C-C in (a).

FIG. 9 is a diagram showing an example of construction of a moving body of the lens module according to the third example of the present invention, wherein (a) is an external plan view seen from the top surface side of the moving body, (b) is a side view taken along a line D-D in (a), and (c) is a perspective view thereof.

FIG. 10 is a diagram showing the basic construction of a lens module according to a fourth example of the present invention, wherein (a) is an external plan view seen from the top surface side of the lens module, and (b) is a sectional side view taken along a line E-E in (a).

### REFERENCE NUMERALS

1, 3, 12, 13, 15, 16, 20, and 21 piezoelectric ceramic elements
2, 2′, 4, 4′, 11, 14, and 19 magnets
5, 5′, and 18 moving bodies
6 and 6′ lens holders
24 first lens holder
23 second lens holder
7 and 7′ housings
8 and 8′ guide pins
9 and 17 weight members
10 vibration damping member
100, 101, 102, and 103 lens modules

### BEST MODES FOR CARRYING OUT THE INVENTION

The first best mode for carrying out the present invention is a lens module which includes a driving body including an electromechanical transducer serving as a driving element and having one end adhered to a magnet and the other end fixed to a stationary member; a moving member constituted by a material attractable to the magnet; a lens holder formed integrally with the moving member; and an optical lens system supported by the lens holder, or formed integrally with the lens holder. The magnetization direction of the magnet is substantially orthogonal to an optical axis direction of the optical lens system and is a radial direction or an outer peripheral direction of the optical lens system. The lens module further includes a lens drive mechanism having a function of moving the lens holder along the optical axis direction by vibrating the magnet using vibrations generated by the electromechanical transducer, and by driving the moving member with the vibrations of the magnet as a driving force.

In the present invention, it is preferable that the moving member is driven by vibrating the magnet by applying a voltage to the electromechanical transducer so as to make the expansion speed and the contraction speed in the electromechanical transducer different from each other.

According to the present invention, it is preferable that between the other end of the electromechanical transducer and the stationary member, a weight member, or the weight member and a vibration damping member are provided.

The second best mode for carrying out the Invention is a lens module which includes a driving body including a first electromechanical transducer serving as a first driving element and having one end adhered to a magnet and the other end fixed to a stationary member and a second electromechanical transducer serving as a second driving element and having one end adhered to the magnet in a direction orthogonal to the displacement generating direction of the first electromechanical transducer and the other end fixed to the stationary member; a moving member having a cylindrical shape and being constituted by a material attractable to the magnet; a first lens holder formed integrally with the moving member; a first optical lens system supported by the first lens holder, or formed integrally with the first lens holder; a second lens holder supported so as to be movable in an optical axis direction of the moving member by a rotational movement of the moving member; and a second optical lens system supported by the second lens holder, or formed integrally with the second lens holder; the magnetization direction of the magnet being substantially orthogonal to an optical axis direction of the first and the second optical lens systems and being a radial direction or an outer peripheral direction of the first and the second optical lens systems. The lens module further comprising a lens drive mechanism having a function of moving the first and the second lens holders along the optical axis direction by vibrating the magnet in the optical axis direction using vibrations generated by the first driving element, and by driving the moving member in the optical axis direction with the vibrations of the magnet as a driving force; and a function of moving the second lens holder along the optical axis direction by vibrating the magnet in an outer peripheral direction of the moving member using vibrations generated by the second driving element, and by rotating the moving member with the vibrations of the magnet as a driving force.

The third best mode for carrying out the Invention is a lens module which includes a driving body including a first electromechanical transducer serving as a first driving element and having one end adhered to a magnet and the other end fixed to a stationary member and a second electromechanical transducer serving as a second driving element and having the other end adhered to the magnet in a direction orthogonal to the displacement generating direction of the first electromechanical transducer and the other end fixed to a weight member; a moving member having a cylindrical shape and being constituted by a material attractable to the magnet; a first lens holder formed integrally with the moving member; a first optical lens system supported by the first lens holder, or formed integrally with the first lens holder; a second lens holder supported so as to be movable in an optical axis direction of the moving member by a rotational movement of the moving member; and a second optical lens system supported by the second lens holder, or formed integrally with the second lens holder; the magnetization direction of the magnet being substantially orthogonal to an optical axis direction of the first and the second optical lens systems and being a radial direction or an outer peripheral direction of the first and the second optical lens systems. The lens module further includes a lens drive mechanism having a function of moving the first and the second lens holders along the optical axis direction by vibrating the magnet in the optical axis direction using vibrations generated by the first driving element, and by driving the moving member in the optical axis direction with the vibrations of the magnet as a driving force; and a function of moving the second lens holder along the optical axis direction by vibrating the magnet in an outer peripheral direction of the moving member using vibrations generated by the second driving element, and by rotating the moving member with the vibrations of the magnet as a driving force.

In the case of the above mentioned lens module, it is preferable that the moving member is driven by vibrating the magnet by applying a voltage to the electromechanical transducer so as to make the expansion speed and the contraction speed in the electromechanical transducer different from each other.

In any one of the lens module according to the present invention, it is preferable that between the other end of the electromechanical transducer and, a weight member is provided, and further between the weight member and the stationary member, a vibration damping member are provided.

In the case of the above mentioned lens module, it is preferable that the moving member is driven by vibrating the magnet by applying a voltage to the first electromechanical transducer so as to make the expansion speed and the contraction speed in the first electromechanical transducer different from each other.

In any one of the lens module according to the present invention, it is preferred that the moving member is driven by vibrating the magnet by applying a voltage to the second electromechanical transducer so as to make the expansion speed and the contraction speed in the second electromechanical transducer different from each other.

In any one of the lens module according to the present invention, it is preferable that between the other end of the first electromechanical transducer and the stationary member, a weight member is provided, or the weight member and a vibration damping member are provided.

In any one of the lens module according to the present invention, it is preferable that between the other end of the second electromechanical transducer and the stationary member, or between the weight member and the stationary member, the vibration damping member is provided.

The present invention will be described in detail with reference to the drawings.

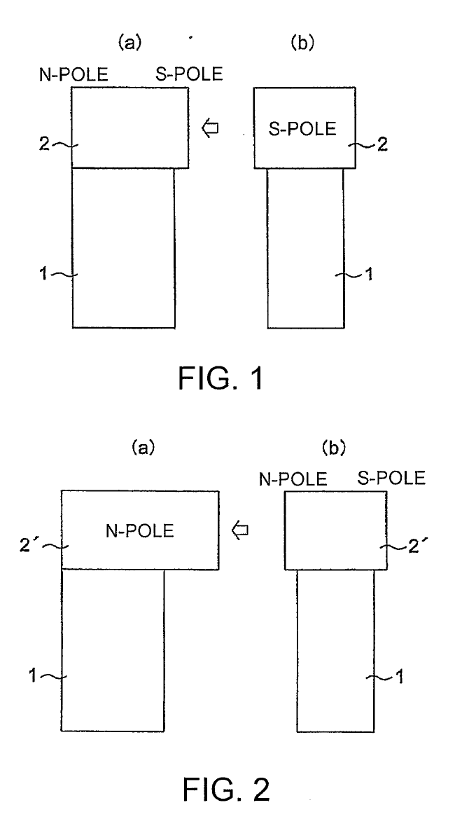

FIG. 1 is a diagram showing an example of schematic construction of a driving body functioning as a critical portion of a lens module according to a first best mode of the present invention, wherein (a) is a side view, and (b) is an end view seen from the right direction indicated by a white arrow in (a).

This driving body is configured by adhering a magnet 2 to one end (end face) of a piezoelectric ceramic element 1 constituted by a laminated piezoelectric ceramic as an electromechanical transducer serving as driving element, in the displacement generating direction (longitudinal direction) of the piezoelectric ceramic element 1, using an epoxy resin or the like.

In the case of a driving body shown in FIGS. 1(a) and (b), regarding the polarity of the magnet 2, referring to FIG. 1(a), the right side in the white arrow direction perpendicular to the longitudinal direction of the piezoelectric ceramic element 1 is an S-pole, and the left side in this direction is an N-pole, so that the end face side shown in FIG. 1(b) is an S-pole. Here, the polarity of the magnet 2 may be modified to another mode.

FIG. 2 is a diagram showing another example of schematic construction of a driving body functioning as a critical portion of a lens module according to the first best mode of the present invention, wherein (a) is a side view, and (b) is an end view seen from the right direction indicated by a white arrow in (a).

This driving body is also configured by adhering a magnet 2′ to one end (end face) of a piezoelectric ceramic element 1 in the displacement generating direction (longitudinal direction) thereof, using an epoxy resin or the like. However, in the case of a driving body shown in FIGS. 2(a) and (b), regarding the polarity of the magnet 2′, referring to FIG. 2(a), the front side of the plane of the figure along the white arrow direction perpendicular to the longitudinal direction of the piezoelectric ceramic element 1 is an N-pole, and the rear side opposite to this is an S-pole. On the end face sides shown in FIG. 2(b), therefore, the left side is an N-pole and the right side is an S-pole.

Anyhow, regarding the piezoelectric ceramic element 1, a material or a structure is appropriately selected as long as a predetermined displacement can be generated. Herein, on the assumption that the lens module is applied to a camera module for use in a mobile phone or a digital still camera, a laminated piezoelectric ceramic is used, considering that the lens module for such a camera needs to be driven by a drive voltage as low as several volts to a dozen volts or so.

For a manufacturing method of the piezoelectric ceramic element 1, a common manufacturing method may be adopted. For example, a ceramic green sheet with a predetermined thickness is made by the doctor blade method or the like, and as an internal electrode, Ag/Pd paste or Cu paste is printed in a predetermined shape on the ceramic green sheet by the screen printing method or the like. Then, after trimming, a predetermined number of layers are laminated, and the laminate is subjected to hot press. Thereafter, the laminate is stamped out into a predetermined shape, and thus a laminated piezoelectric ceramic is manufactured through processes of debindering and sintering.

While the material for the magnets 2 and 2′ are not particularly limited, when size reduction is to be promoted, it is recommendable to use a neodymium based magnet or a samarium-cobalt based magnet to ensure a sufficient attractive force. The magnets 2 and 2′ are arranged so that a magnetization direction of the N and S poles is orthogonal to an optical axis of the optical lens system. With this arrangement, since a magnetic flux distribution in a magnetic circuit composed of the magnet 2 and a moving member can be formed symmetrically about a moving direction of the optical lens system, the optical lens system can be drived stably without causing a difference in a driving force between in a moving direction of the optical lens system and in a direction reverse to the moving direction.

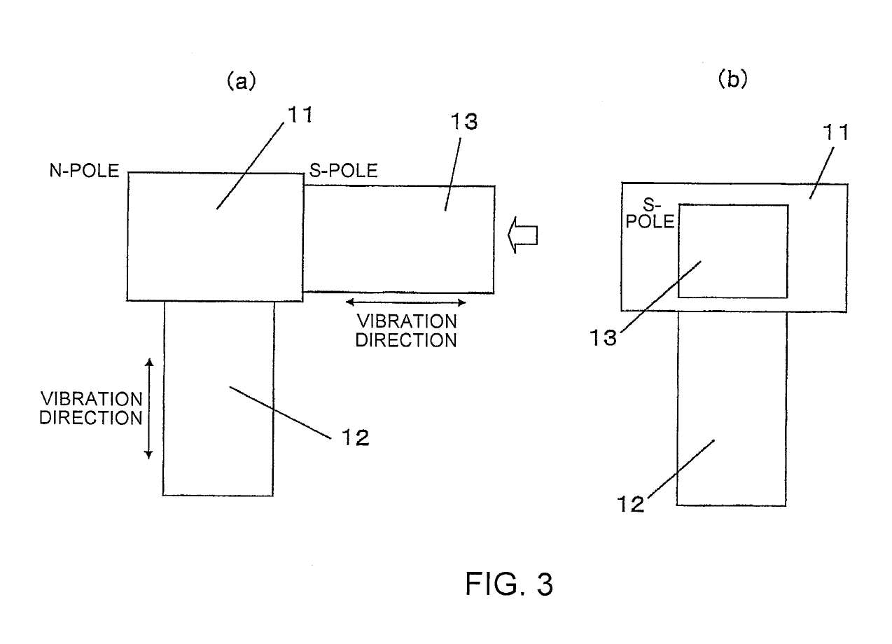

FIG. 3 is a diagram showing an example of schematic construction of a driving body functioning as a critical portion of a lens module according to a second best mode of the present invention, wherein (a) is a side view, and (b) is an end view seen from the right direction indicated by a white arrow in (a).

This driving body is configured by adhering a magnet 11 to one end (end face) of a piezoelectric ceramic element 12 constituted by a laminated piezoelectric ceramic as an electromechanical transducer serving as a first driving element, in the displacement generating direction (longitudinal direction) of the piezoelectric ceramic element 12, using an epoxy resin or the like. Furthermore, one end (end face) of another piezoelectric ceramic element 13 is adhered to the magnet 11 in the displacement generating direction (longitudinal direction) thereof, using an epoxy resin or the like. Here, adhered positions of the two ceramic elements are arranged so that their displacement generating directions orthogonally intersect each other. The polarity of the magnet 11 in this case is the same as that in FIG. 1, viewing from the piezoelectric ceramic element 12.

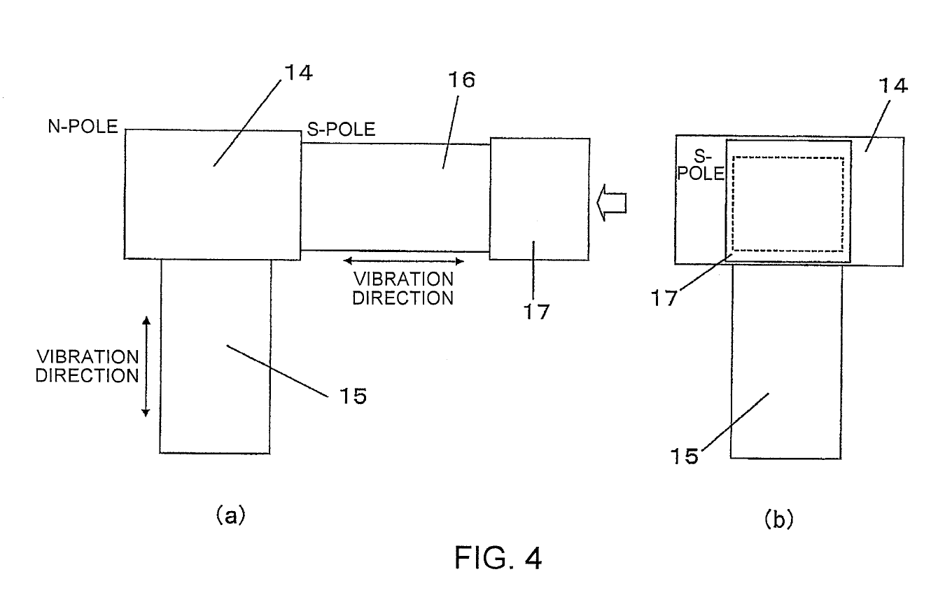

FIG. 4 is a diagram showing an example of schematic construction of a driving body functioning as a critical portion of a lens module according to a third best mode of the present invention, wherein (a) is a side view, and (b) is an end view seen from the right direction indicated by a white arrow in (a).

As in the case of FIG. 6, this driving body is configured by adhering two piezoelectric ceramic elements 15 and 16 to a magnet 14 using an epoxy resin or the like. Moreover, a weight member 17 is adhered to the other end of the piezoelectric ceramic element 16 using an epoxy resin or the like. The polarity of the magnet 14 is the same as that in FIG. 1, viewing from the piezoelectric ceramic element 15.

The material for the weight member 17 is not particularly limited. The material has only to be determined based on weight balance between the magnet and the weight member 17. Beside an iron based material such as stainless steel, a high density metal such as a tungsten alloy is preferably used as a material for the weight member 17.

### EXAMPLES

Hereinafter, using some examples and comparative examples, a lens module according to the present invention will be described in detail with reference to the drawings. It is obvious that the present invention is not limited to these examples.

### First Example

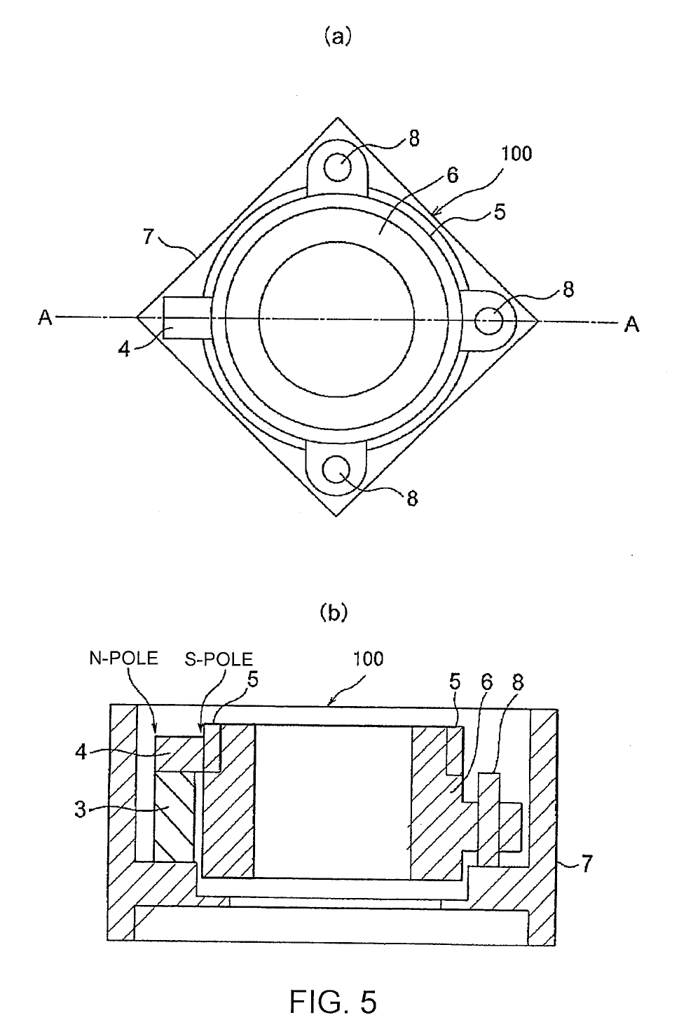

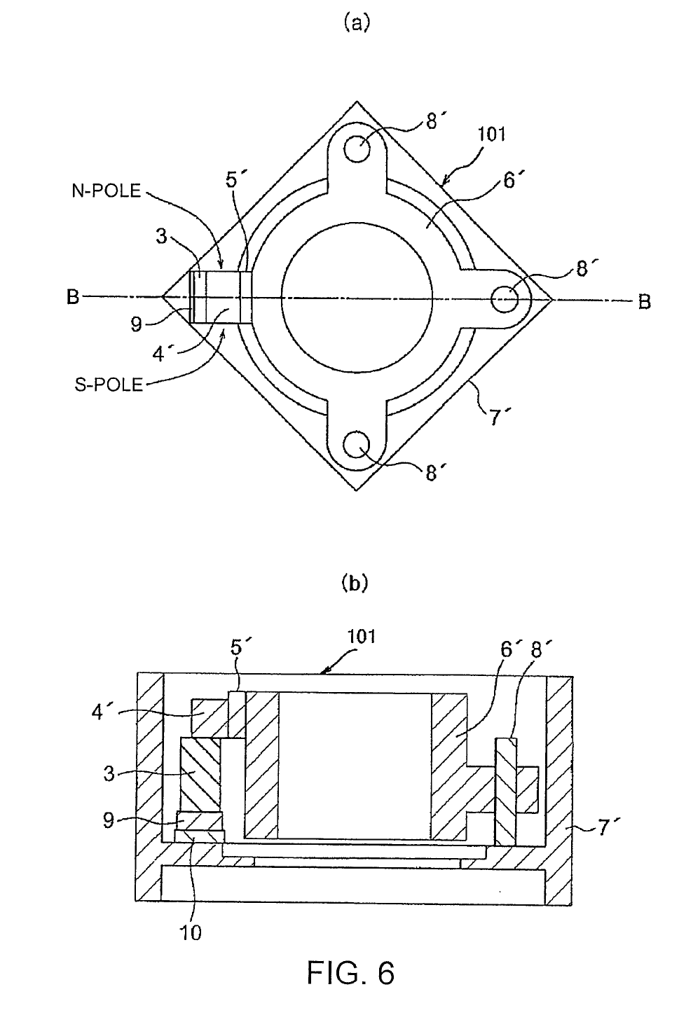

FIG. 5 is a diagram showing the basic construction of a lens module according to a first example of the present invention, wherein (a) is an external plan view seen from the top surface side of the lens module, and (b) is a sectional side view taken along a line A-A in (a).

In this lens module, as a moving body, the type shown in FIGS. 1(a) and (b) is used. This lens module has a structure wherein a lens holder 6 that mounts a moving body 5 as a moving member constituted by a material attractable to a magnet 4 is mounted on a housing 7 using guide pins 8, and wherein one end face of a piezoelectric ceramic element 3 constituted by a laminated piezoelectric ceramic is adhered to the magnet 4 in the displacement generating direction (longitudinal direction) of the piezoelectric ceramic element 3, and the other end face thereof is adhered to the housing 7 serving as a stationary member, with the moving body 5 as the moving member constituted by a material attractable to the magnet 4 and the magnet 4 being attracted by a magnetic force. In addition, the lens holder 6 supporting the moving body 5 is movably supported by the guide pins 8 to prevent tilt or rotation.

Although a predetermined optical lens system is arranged within the lens holder 6, it is herein omitted from illustration. Also, although the moving body 5 and the lens holder 6 are here treated as members different from each other, they can also be integrally formed as an identical member using the same material. The magnet 4 is magnetized so that, as shown in FIG. 5(b), the side contacting the moving body 5 becomes an S-pole and that the opposite side thereof becomes an N-pole. That is, the magnetization direction of the magnet 4 is substantially orthogonal to an optical axis direction of an optical lens system (not shown) mounted on a central portion of the lens holder 6, and is a radial direction of the optical lens system.

The lens module according to the first example has a lens drive mechanism having a function of moving the lens holder 6 along the optical axis by vibrating the magnet 4 using vibrations generated by the piezoelectric ceramic element 3, and by driving the moving body 5 with the vibrations of the magnet 4 as a driving force.

In this connection, in the lens module according to the first example, vibrations occurring at the piezoelectric ceramic element 3 are conveyed to the housing 7, and therefore, if the lens module is used as a camera module, an image censor (not shown) may suffer from influences of vibration noise and the like.

Here, a specific example of the lens module according to the first example will be explained. As a piezoelectric ceramic element 3, a laminated piezoelectric ceramic was used that is, in the cross section, 1.0 mm long, 1.0 mm wide, and 2.0 mm high, and that generates a displacement of roughly 0.1 μm with respect to an applied voltage of ±3 V. A driving member was produced by adhering a neodymium based magnet that is, in the cross section, 1.2 mm long, 1.5 mm wide, and 1.0 mm high, to one end of the above-described piezoelectric ceramic element 3 using a thermosetting epoxy resin. Then, a housing 7 constituted by poly-carbonate material and having a shape as shown in FIGS. 5(a) and (b) is produced, and the other end of the piezoelectric ceramic element 3 is adhered to the position shown by FIG. 5(b) with the epoxy resin.

Next, a moving body 5 constituted by a material SUS430 and having dimensions: an outer diameter of 8.5 mm, an inner diameter of 7.5 mm, and a height of 1.5 mm was produced, and this moving body 5 was adhered to the lens holder 6 constituted by poly-carbonate material with the epoxy resin. Then, five lens modules according to the first example having the structure shown in FIGS. 5(a) and (b) by supporting the lens holder 6 by the guide pins 8 made of SUS304 material, and by attracting the magnet 4 and the moving body 5.

Regarding the lens modules according to the first example, although the moving strokes of the lens holders 6 are each about 0.5 mm, the stroke can be increased by increasing the height of the moving body 5.

### Second Example

FIG. 6 is a diagram showing the basic construction of a lens module according to a second example of the present invention, wherein (a) is an external plan view seen from the top surface side of the lens module, and (b) is a sectional side view taken along a line B-B in (a).

In this lens module, as a driving body, the type shown in FIGS. 2 (a) and (b) is used. This lens module is intended for the prevention of the leakage of vibrations into the housing 7 conceivable in the structure in the first example. However, this lens module shares a common basic structure with the lens module in the first example. That is, the lens module in the second example has a structure wherein a lens holder 6′ that mounts a moving body 5′ as a moving member constituted by a material attractable to a magnet 4′ is mounted on a housing 7′ using guide pins 8′, and wherein one end face of a piezoelectric ceramic element 3 constituted by a laminated piezoelectric ceramic is adhered to the magnet 4′ in the displacement generating direction (longitudinal direction) of the piezoelectric ceramic element 3, and the other end face thereof is adhered to the housing 7′, with the moving body 5′ and the magnet 4′ being attracted by a magnetic force.

However, the structure of the lens module according to the second example differs from that of the lens module according to the first example in that: the lens holder 6′ is provided with the rectangular moving body 5′ fixed by adhering at a location of the lens holder 6′, and regarding the housing 7′ itself, the bottom thereof is made thin so as to allow higher guide pins 8 to be installed; between the piezoelectric ceramic element 3 and the housing 7′, there is provided a weight member 9 and a vibration damping member 10 constituted by a vibration damping material; and as shown in FIG. 4(a), the magnetization direction of the magnet 4′ is outer peripheral direction of the optical lens system so that one side of the magnet 4′ becomes an N-pole and the other side becomes an S-pole along the outer peripheral direction of the moving body 5′.

The lens module according to the second example also has a lens drive mechanism having a function of moving the lens holder 6′ along the optical axis direction by vibrating the magnet 4′ using vibrations generated by the electromechanical transducer 3, and by driving the moving body 5′ with the vibrations of the magnet 4′ as a driving force. However, vibrations generated by the piezoelectric ceramic element 3 are conveyed to the magnet 4′ and the weight member 9, but since the vibration damping member 10 has been provided between the weight member 9 and the housing 7′, the leakage of vibrations is inhibited. This significantly reduces influence on imaging property of the image sensor (not shown) even if it is used as a camera module.

In the second example, although arranging the weight member 9 and the vibration damping member 10 constituted by the vibration damping material between the piezoelectric ceramic element 3 and the housing 7′ inhibits the leakage of vibration to the housing 7, the arrangement of only the weight member 9 allows inhibition of the vibration leakage. By adhering the weight member 9 to the piezoelectric ceramic element 3, the position of the center of gravity of the whole of the magnet 4′, the piezoelectric ceramic element 3, and the weight member 9 shifts toward the weight member 9. As a result, almost all of vibrations of the piezoelectric ceramic element 3 can be generated on the side of the magnet 4′.

That is, the leakage amount of vibrations to the housing 7 is determined based on densities and dimensions of the magnet 4′, the piezoelectric ceramic element 3, and the weight member 9, but the presence/absence of the vibration damping member 10 and the positioning thereof may be determined based on performance required of the lens module.

While the moving body 5′ shown in FIGS. 6(a) and (b) has been explained as the structure in which a rectangular plate material is adhered to the lens holder 6′, even if these moving body 5′ and lens holder 6′ are used for the configurations (moving body 5 and lens holder 6) in the first example, an equal effects will be produced.

Regarding the lens module according to the second example, the weight member 9 was used that is made of SUS304 material and that is 1.5 mm long, 1.5 mm wide, and 1 mm thick, and as the vibration damping member 10, Miyafreq (manufactured by MIYASAKA Rubber Co., Ltd; thickness: 0.5 mm) was used. As in the case of the first example, five lens module having the structure shown in FIGS. 6(a) and (b) were produced.

Hereinafter, operations of the driving mechanisms of the lens modules according to the first and the second examples will be described.

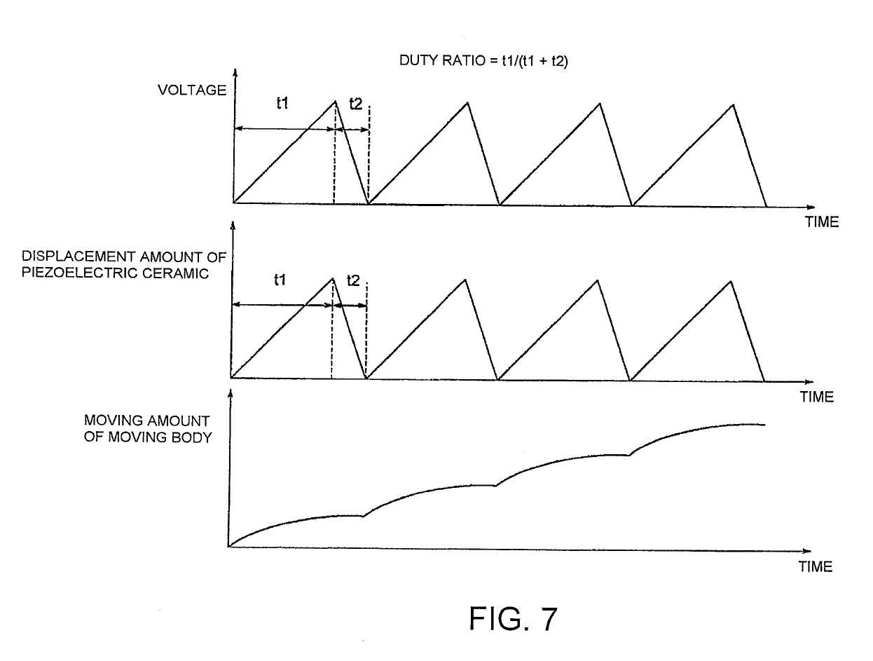

FIG. 7 is a timing chart showing the relationship among the drive voltage change with time, of the piezoelectric ceramic elements 3 provided in the lens modules according to the first and the second examples, the displacement amount of the piezoelectric ceramic elements 3, and the moving amount of the moving bodies 5 and 5′.

In these lens modules, if the height of the piezoelectric ceramic element 3 is made about 1.5 to 2 mm, the resonant frequency becomes about 300 kHz or more, and therefore, if the frequency of an applied AC voltage (drive voltage) is made about 20 to 30 kHz, influence of harmonic components is almost negligible, thereby causing an input voltage waveform and an output displacement waveform to assume a similar shape.

As shown in FIG. 7, regarding an input voltage (drive voltage) waveform constituted by a triangular waveform, if time periods t1 and t2 during which corresponding inclinations of the triangular waveform are mutually different are set so as to satisfy the relation t1>t2, the piezoelectric ceramic element 3 slowly expands taking the time period t1 and rapidly contracts during the time period t2, in terms of the displacement amount. Here, suppose that the time period t2 is set so as to allow the occurrence of an acceleration exceeding the maximum stationary frictional force generated between the moving bodies 5 and 5′ and the magnets 4 and 4′, respectively. Then, in the time period t1, the moving bodies 5 and 5′ and the piezoelectric ceramic element 3 move together, while, in the time period t2, a slip occurs between the moving bodies 5 and 5′ and the piezoelectric ceramic element 3. By successively repeating this process, the moving bodies 5 and 5′ and the lens holder 6 and 6′ move unidirectionally to the stationary members (housings 7 and 7′), respectively.

Here, if duty ratio is defined by a relation:duty ratio=t1/(t1+t2), using the time periods t1 and t2, the speed and moving direction of each of the moving bodies 5 and 5′ can be controlled by changing the duty ratio.

In the foregoing, as shown in FIG. 7, the case where an input voltage (drive voltage) waveform constituted by a triangular waveform is provided has been described, but the piezoelectric ceramic element 3 can be driven also by providing an input voltage (drive voltage) waveform constituted by a square waveform adjusted in frequency in accordance with the shape of components.

### Comparative Example

In a comparative example, which has a similar structure to that in the second example, five lens modules were produced each of which is configured to be magnetized with the magnetization direction of the magnet 4′ as the longitude direction of the piezoelectric ceramic element 3, i.e. up-and-down direction, which is the height direction of the module.

An AC Voltage of ±3 V was applied to the piezoelectric ceramic elements 3 in lens modules (specimens No. 1 to 5 each) according to the above-described first and second example and the comparative example, and moving speeds of the lens holders 6 and 6′ were measured using a Laser Doppler Vibrometer. Table 1 shows the results.

TABLE 1

| | First Example | | Second Example | | Comparative Example | |
|---|---|---|---|---|---|---|
| | Ascent | Descent | Ascent | Descent | Ascent | Descent |
| | (mm/sec) | (mm/sec) | (mm/sec) | (mm/sec) | (mm/sec) | (mm/sec) |
| No. 1 | 1.25 | 1.22 | 1.01 | 1.19 | 0.80 | 1.58 |
| No. 2 | 1.27 | 1.26 | 0.99 | 1.14 | 0.78 | 1.64 |
| No. 3 | 1.20 | 1.10 | 1.05 | 1.22 | 0.77 | 1.46 |
| No. 4 | 1.23 | 1.25 | 1.07 | 1.21 | 0.71 | 1.42 |
| No. 5 | 1.18 | 1.24 | 1.06 | 1.25 | 0.82 | 1.80 |

Table 1 shows an average moving speed when the lens holder specimens are vertically moved with a stroke of 0.5 mm. For the applied AC voltages, voltage waveforms were made triangular waveforms with duty ratios 90% and 10%, at a drive frequency of 25 kHz. Under these applied AC voltage conditions, the moving speeds of the specimens were measured by reciprocating the lens holders 6 and 6′. Regarding moving directions, when the lens holders 6 and 6′ move upward, the term “ascent” (mm/sec) is used, and when the lens holders 6 and 6′ move downward, the term “descent” (mm/sec) is used.

It can be seen from the above Table 1, that for the lens modules according to the first example, the ratio between the ascending speed and the descending speed of the lens holder 6 is in a range from 0.952 to 1.025, and that for the lens modules according to the second example, the ratio between the ascending speed and the descending speed of the lens holder 6′ is in a range from 0.848 to 0.884. This indicates that the descending speed is higher in the second example as compared with the first example, but the difference between the ascending speed and the descending speed in the second example falls within 14%. In contrast, for the lens modules according to the comparative example, it is observed that the ratio between the ascending speed and the descending speed of the lens holder 6′ is in a range from 0.456 to 0.506, and that the difference between the ascending speed and the descending speed is 50% or more.

It was thus ascertained that, as compared with the lens modules according to the comparative example, the lens modules according to the first and the second examples have no large differences between the ascending and descending speeds of the respective lens holders 6 and 6′, and that they have very small variations in speed.

### Third Example

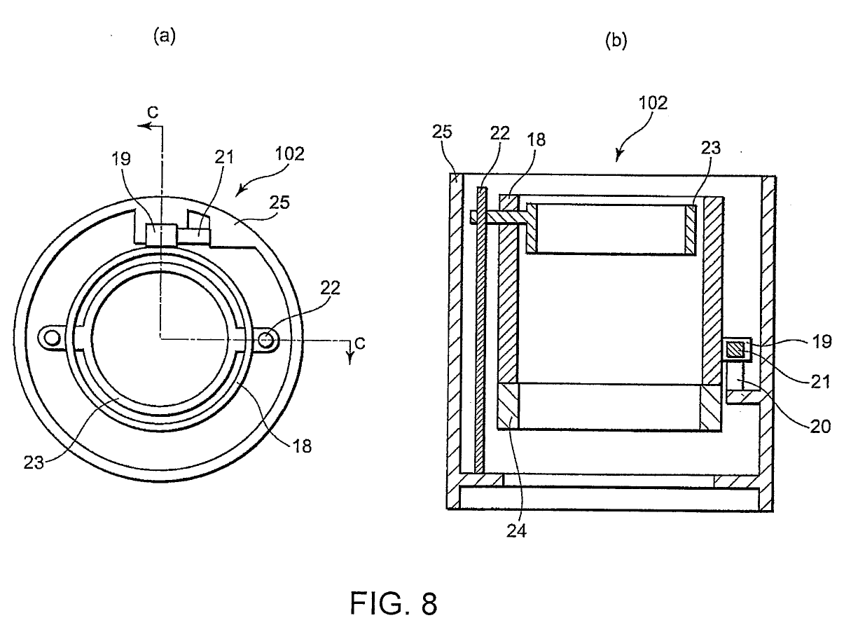

FIG. 8 is a diagram showing the basic construction of a lens module according to a third example of the present invention, wherein (a) is an external plan view seen from the top surface side of the lens module, and (b) is a sectional side view taken along a line C-C in (a).

The lens module 102 uses, as a driving body, the type shown in FIGS. 6 (a) and (b). The lens module has a structure in which a first lens holder 24 mounts a moving body 18 as a moving member constituted by a material attractable to a magnet 19, a second lens holder 23 is supported so as to be movable in an axis direction (optical axis direction) of the moving body 18 with respect to the rotation of the moving body 18 in the axial direction, and the first and the second lens holders are attracted by a magnetic force of the magnet 19 as in the case of the first and the second examples.

Here, one end of a piezoelectric ceramic element 20 is adhered to a housing 25 serving as a stationary member, and the other end thereof is adhered to the magnet 19. Also, one end of a piezoelectric ceramic element 21 is adhered to the housing 25 serving as a stationary member, and the other end thereof is adhered to the magnet 19. That is, the displacement generating direction of the piezoelectric ceramic element 20 serving as a first driving element and the displacement generating direction of the piezoelectric ceramic element 21 serving as a second driving element substantially orthogonally intersect each other, with the piezoelectric ceramic elements 20 and 21 being each adhered to the magnet 19. The vibration direction of the piezoelectric ceramic element 20 is along the optical axis of the second lens holders 23 and 24, while the vibration direction of the piezoelectric ceramic element 21 is along the peripheral direction of the moving body 18.

In the third example, the magnet 19 is magnetized so that the side contacting the moving body 18 becomes an S-pole and that the opposite side thereof becomes an N-pole as in the case of the first example. That is, the magnetization direction of the magnet 19 is substantially orthogonal to an optical axis direction of an optical lens system (not shown) mounted on a central portion of the lens holders 24 and 23, and is a radial direction of the optical lens system.

By vibrating the piezoelectric element 20, the magnet 19 is vibrated in the optical axis direction, and the moving body 18 is driven along the optical axis, the lens holders 23 and 24 are simultaneously moved in the optical axis direction. By vibrating the piezoelectric element 21, the magnet 19 is vibrated in the peripheral direction of the moving body 18, to thereby rotate the moving body 18. The rotation of the moving body 18 moves only the second lens holder 23 in the optical axis direction.

Guide pins 22 are fixed to the housing 25 by adhering, press fitting, or the like. In the second lens holder 23, the moving body 18 is rotatably supported, and simultaneously, it is movably supported by the guide pins 22.

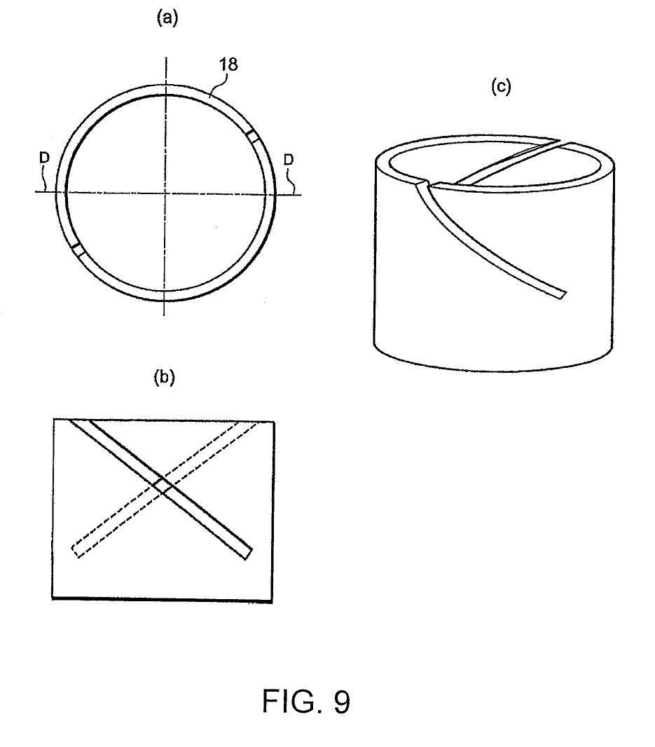

As a structure for moving the second lens holder 23 along the optical axis by the rotation of the moving body 18, a structure such as a lead screw may be used. FIG. 9(a) is an external plan view seen from the top surface side of the moving body 18, (b) is a sectional side view taken along a line D-D in (a), and (c) is a perspective view thereof.

The moving body 18 here has a cylindrical shape, and has two grooves to assume a lead screw configuration. The second lens holder 23 is installed along the grooves of the moving body 18, and movably supported by the guide pins 22, whereby the second lens holder 23 moves toward the axial direction with respect to the rotation of the moving body 18.

The lens module according to the third example also has a lens drive mechanism having a function of moving the lens holders 24 and 23 along the optical axis direction by vibrating the magnet 19 in the optical axis direction using vibrations generated by the piezoelectric ceramic element 20, and by driving the moving body 23 with the vibrations of the magnet 19 as a driving force. Concurrently, the lens module according to the third example has a lens drive mechanism having a function of moving only the second lens holder 23 in the optical axis direction by vibrating the magnet 19 in the peripheral direction of the moving body 18 using vibrations generated by the piezoelectric ceramic element 21, and by rotating the moving body 18 using the vibrations of the magnet 19 as a driving force. That is, in the lens module according to the third example, the auto-focus function and the zoom function can be implemented in a single moving body.

### Fourth Example

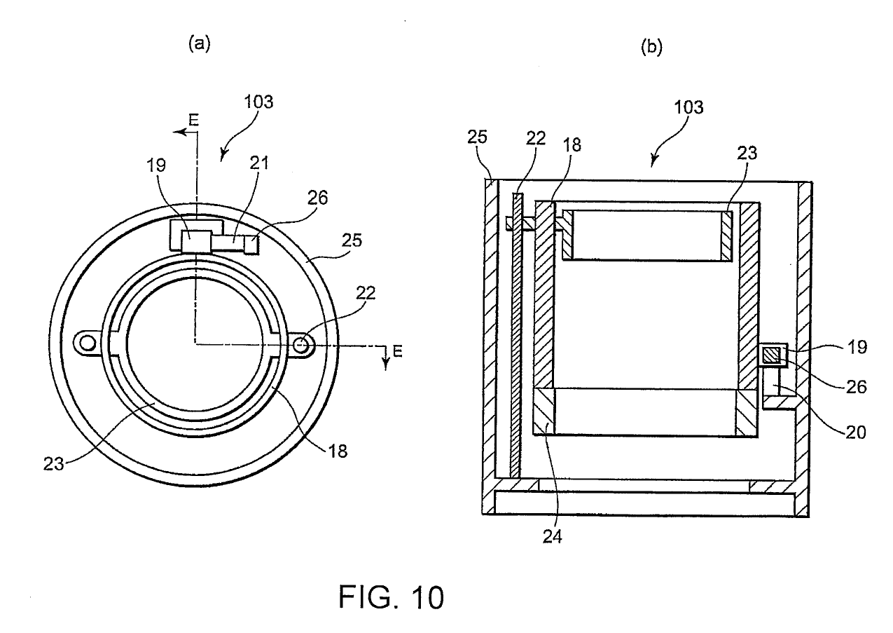

FIG. 10 is a diagram showing the basic construction of a lens module according to a fourth example of the present invention, wherein (a) is an external plan view seen from the top surface side of the lens module, and (b) is a sectional side view taken along a line E-E in (a).

As in the case of the third example, a lens module according to the fourth example can embody the auto-focus function and the zoom function in a single moving body. In this case, by adhering a weight member 26 to an end face of the piezoelectric ceramic element 21, a quite equivalent function can be provided even without adhesion to the housing 25 as a stationary member. Thus, the structure can be further simplified.

In the third and fourth examples, by providing the weight member, or by providing the weight member and the vibration damping member between the piezoelectric ceramic element adhered to the housing and the housing, vibration leakage into the housing can also prevented, as in the case of the second example.

### INDUSTRIAL APPLICABILITY

As described above, the lens module according to the present invention is applied to an optical device having an auto-focus mechanism and/or a zoom mechanism, such as a digital video camera, a digital camera, a camera for use in a mobile phone, or the like.

1-11. (canceled)

12. A lens module comprising an optical lens system and a lens drive mechanism, the lens drive mechanism including:
a driving body including an electromechanical transducer serving as a driving element and having one end adhered to a magnet and another end fixed to a stationary member;
a moving member comprised of a material attractable to the magnet; and
a lens holder formed integrally with the moving member;
wherein the optical lens system is one of (i) supported by the lens holder, and (ii) formed integrally with the lens holder;
wherein the magnet has a magnetization direction which is substantially orthogonal to an optical axis direction of the optical lens system and which is one of (i) a radial direction and (ii) an outer peripheral direction of the optical lens system; and
wherein the lens drive mechanism has a function of moving the lens holder along the optical axis direction by vibrating the magnet using vibrations generated by the electromechanical transducer, and by driving the moving member with the vibrations of the magnet as a driving force.

13. The lens module according to claim 12, wherein the moving member is driven by vibrating the magnet by applying a voltage to the electromechanical transducer so as to make an expansion speed and a contraction speed in the electromechanical transducer different from each other.

14. The lens module according to claim 12, wherein, between the another end of the electromechanical transducer and the stationary member, there is provided one of (i) a weight member and (ii) the weight member and a vibration damping member.

15. A lens module comprising a first optical lens system, a second optical lens system, and a lens drive mechanism, the lens drive mechanism including:
a driving body including:
a first electromechanical transducer serving as a first driving element and having one end adhered to a magnet and another end fixed to a stationary member; and
a second electromechanical transducer serving as a second driving element and having one end adhered to the magnet in a direction orthogonal to the displacement generating direction of the first electromechanical transducer and another end fixed to the stationary member;
a moving member having a cylindrical shape and being comprised of a material attractable to the magnet;
a first lens holder formed integrally with the moving member; and
a second lens holder supported so as to be movable in an optical axis direction of the moving member by a rotational movement of the moving member;
wherein the first optical lens system is one of (i) supported by the first lens holder and (ii) formed integrally with the first lens holder;
wherein the second optical lens system is one of (i) supported by the second lens holder and (ii) formed integrally with the second lens holder;
wherein the magnet has a magnetization direction which is substantially orthogonal to an optical axis direction of the first and the second optical lens systems and which is one of (i) a radial direction and (ii) an outer peripheral direction of the first and the second optical lens systems; and
wherein the lens drive mechanism has:
a function of moving the first and the second lens holders along the optical axis direction by vibrating the magnet in the optical axis direction using vibrations generated by the first driving element, and by driving the moving member in the optical axis direction with the vibrations of the magnet as a driving force; and
a function of moving the second lens holder along the optical axis direction by vibrating the magnet in an outer peripheral direction of the moving member using vibrations generated by the second driving element, and by rotating the moving member with the vibrations of the magnet as a driving force.

16. A lens module comprising a first optical lens system, a second optical lens system, and a lens drive mechanism, the lens drive mechanism including:
a driving body including:
a first electromechanical transducer serving as a first driving element and having one end adhered to a magnet and another end fixed to a stationary member; and
a second electromechanical transducer serving as a second driving element and having one end adhered to the magnet in a direction orthogonal to the displacement generating direction of the first electromechanical transducer and another end fixed to a weight member;
a moving member having a cylindrical shape and being comprised of a material attractable to the magnet;
a first lens holder formed integrally with the moving member; and
a second lens holder supported so as to be movable in an optical axis direction of the moving member by a rotational movement of the moving member;
wherein the first optical lens system is one of (i) supported by the first lens holder and (ii) formed integrally with the first lens holder;
wherein the second optical lens system is one of (i) supported by the second lens holder and (ii) formed integrally with the second lens holder;
wherein the magnet has a magnetization direction which is substantially orthogonal to an optical axis direction of the first and the second optical lens systems and which is one of (i) a radial direction and (ii) an outer peripheral direction of the first and the second optical lens systems; and
wherein the lens drive mechanism has:
a function of moving the first and the second lens holders along the optical axis direction by vibrating the magnet in the optical axis direction using vibrations generated by the first driving element, and by driving the moving member in the optical axis direction with the vibrations of the magnet as a driving force; and
a function of moving the second lens holder along the optical axis direction by vibrating the magnet in an outer peripheral direction of the moving member using vibrations generated by the second driving element, and by rotating the moving member with the vibrations of the magnet as a driving force.

17. The lens module according to claim 16, wherein the weight member is further fixed to the stationary member.

18. The lens module according to claim 15, wherein the moving member is driven by vibrating the magnet by applying a voltage to the first electromechanical transducer so as to make an expansion speed and a contraction speed in the first electromechanical transducer different from each other.

19. The lens module according to claim 15, wherein the moving member is driven by vibrating the magnet by applying a voltage to the second electromechanical transducer so as to make an expansion speed and a contraction speed in the second electromechanical transducer different from each other.

20. The lens module according to claim 15, wherein, between the another end of the first electromechanical transducer and the stationary member, there is provided one of (i) a weight member and (ii) the weight member and a vibration damping member.

21. The lens module according to claim 15, wherein, between the another end of the second electromechanical transducer and the stationary member, a vibration damping member is provided.

22. The lens module according to claim 12, wherein the electromechanical transducer comprises a laminated piezoelectric ceramic element.

23. The lens module according to claim 13, wherein the electromechanical transducer comprises a laminated piezoelectric ceramic element.

24. The lens module according to claim 14, wherein the electromechanical transducer comprises a laminated piezoelectric ceramic element.

25. The lens module according to claim 15, wherein each of the first and the second electromechanical transducers comprises a laminated piezoelectric ceramic element.

26. The lens module according to claim 18, wherein each of the first and the second electromechanical transducers comprises a laminated piezoelectric ceramic element.

27. The lens module according to claim 19, wherein each of the first and the second electromechanical transducers comprises a laminated piezoelectric ceramic element.

28. The lens module according to claim 20, wherein each of the first and the second electromechanical transducers comprises a laminated piezoelectric ceramic element.

29. The lens module according to claim 21, wherein each of the first and the second electromechanical transducers comprises a laminated piezoelectric ceramic element.

30. The lens module according to claim 16, wherein the moving member is driven by vibrating the magnet by applying a voltage to the first electromechanical transducer so as to make an expansion speed and a contraction speed in the first electromechanical transducer different from each other.

31. The lens module according to claim 16, wherein the moving member is driven by vibrating the magnet by applying a voltage to the second electromechanical transducer so as to make an expansion speed and a contraction speed in the second electromechanical transducer different from each other.

32. The lens module according to claim 16, wherein, between the another end of the first electromechanical transducer and the stationary member, there is provided one of (i) a weight member and (ii) the weight member and a vibration damping member.

33. The lens module according to claim 16, wherein, between the weight member and the stationary member, a vibration damping member is provided.

34. The lens module according to claim 16, wherein each of the first and the second electromechanical transducers comprises a laminated piezoelectric ceramic element.

35. The lens module according to claim 17, wherein each of the first and the second electromechanical transducers comprises a laminated piezoelectric ceramic element.

36. The lens module according to claim 30, wherein each of the first and the second electromechanical transducers comprises a laminated piezoelectric ceramic element.

37. The lens module according to claim 31, wherein each of the first and the second electromechanical transducers comprises a laminated piezoelectric ceramic element.

38. The lens module according to claim 32, wherein each of the first and the second electromechanical transducers comprises a laminated piezoelectric ceramic element.

39. The lens module according to claim 33, wherein each of the first and the second electromechanical transducers comprises a laminated piezoelectric ceramic element.
